(19) United States
(12) Patent Application Publication
(10) Pub. No.: US 2002/0148663 A1
(43) Pub. Date: Oct. 17, 2002

(54) Drive device of a motorized scooter

(76) Inventor: Hui-Lung Chang, Taichung (TW)

Correspondence Address: Hui-Lung Chang, 58 MA YUAN WEST ST., TAICHUNG, TW

(21) Appl. No.: 09/834,541

(22) Filed: Apr. 15, 2001

(51) Int. Cl. B62K 5/02

(52) U.S. Cl. 180/210; 180/211

(57) ABSTRACT

A drive device of a motorized scooter primarily includes a horizontal connecting plate and a vertical connecting plate mounted on a frame of the scooter and defining a horizontal connecting hole and a vertical connecting hole. The horizontal connecting hole and the vertical connecting hole are pivoted to the axial hole and the radial threaded hole of the wheel seat. The horizontal connecting hole and the vertical connecting hole have a slightly greater diameter, so that the wheel seat may deflect horizontally and vertically. The wheel seat is respectively pivoted with two wheel covers by a pin and a torsion spring. The front wheel cover in contact with the wheels to provide a brake effect. The inside of the rear wheel cover is secured with a motor whose two ends are fitted with a drive wheel to contact and drive the wheels.

### BACKGROUND OF THE INVENTION

1. Field of the Invention

The present invention relates to a drive device of a motorized scooter.

2. Description of the Related Art

A conventional motorized scooter comprises a motor, a worm, and a worm wheel engaging and driving rear wheels on a propeller shaft to move forward, and a brake mounted on the rear wheels, while the handlebar is provided with a switch and an emergency brake. The rider may press the switch to start the motor which drives the rear wheels to move the motorized scooter forward. The rider may use the emergency brake and the brake to brake the rear wheels. When the switch is turned off, the motor stops operation so as to stop the motorized scooter,

However, the conventional motorized scooter has the following disadvantages.

1. The rear wheel at the outer side easily leaves the ground when turning the scooter, so that the scooter easily falls down.

2. When the scooter is ridden on a rugged road, the frame and the rear wheels of the scooter are affected by the vibration, thereby causing difficulty in manipulation, and causing an uncomfortable sensation to the rider.

3. When the motor is started, the accident pulse of the motor causes the rider to lean rearward, so that the front wheel is lifted, thereby affecting the balance of the scooter.

4. The scooter is not provided with a shock absorber, so that the vibration is directly transmitted to the frame and the rider, thereby causing an uncomfortable sensation to the rider.

### SUMMARY OF THE INVENTION

In accordance with the present invention, there is provided a drive device of a motorized scooter, comprising:

a horizontal connecting plate mounted on a rear end of a frame of a scooter and defining a horizontal connecting hole, a vertical connecting plate mounted on the horizontal connecting plate and defining a vertical connecting hole, the horizontal connecting hole pivoted to an axial hole of a wheel seat, the vertical connecting hole pivoted to a radial threaded hole of the wheel seat, the horizontal connecting hole and the vertical connecting hole having a slightly greater diameter, so that the wheel seat may deflect horizontally and vertically, the wheel seat having two sides provided with two wheels and a rear side provided with an auxiliary wheel having a smaller diameter, the wheel seat having a top having a front side and a rear side respectively pivoted with two wheel covers by a pin and a torsion spring, the front wheel cover in contact with the two wheels to provide a brake effect, the inside of the rear wheel cover secured with a motor, and the two ends of the motor fitted with a drive wheel to contact and drive the two wheels.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a drive device of a motorized scooter in accordance with the present invention;

FIG. 2 is a side plan cross-sectional assembly view of the drive device of a motorized scooter as shown in FIG. 1;

FIG. 3 is a schematic operational view of the drive device of a motorized scooter as shown in FIG. 2;

FIG. 4 is a schematic operational view of the drive device of a motorized scooter as shown in FIG. 2;

FIG. 5 is a partially cut-away rear plan assembly view of the drive device of a motorized scooter as shown in FIG. 1;

FIG. 6 is a schematic operational view of the drive device of a motorized scooter as shown in FIG. 5;

FIG. 7 is a schematic operational view of the drive device of a motorized scooter as shown in FIG. 2;

FIG. 8 is a rear plan assembly view of the drive device of a motorized scooter as shown in FIG. 1; and

FIG. 9 is a top plan assembly view of the drive device of a motorized scooter as shown in FIG. 1.

### DETAILED DESCRIPTION OF THE INVENTION

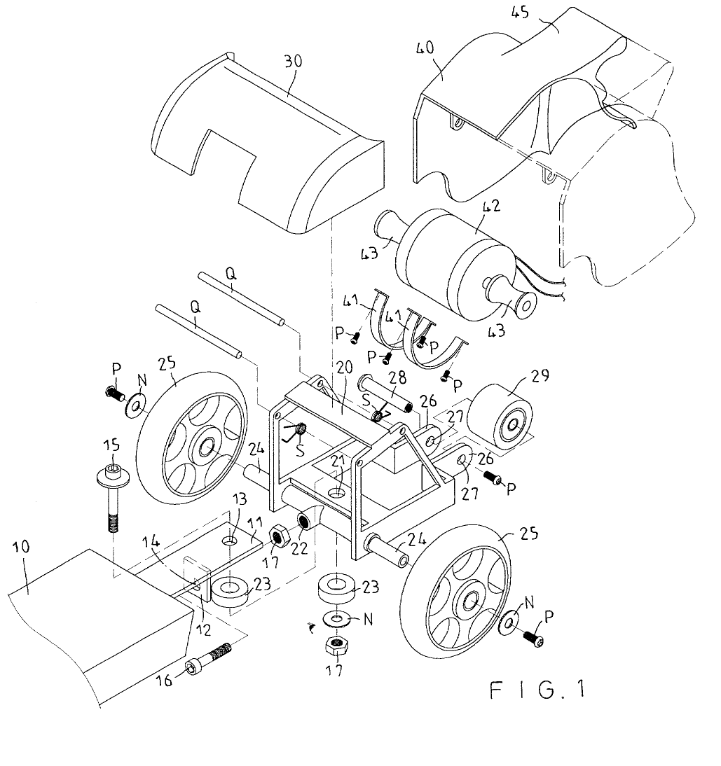

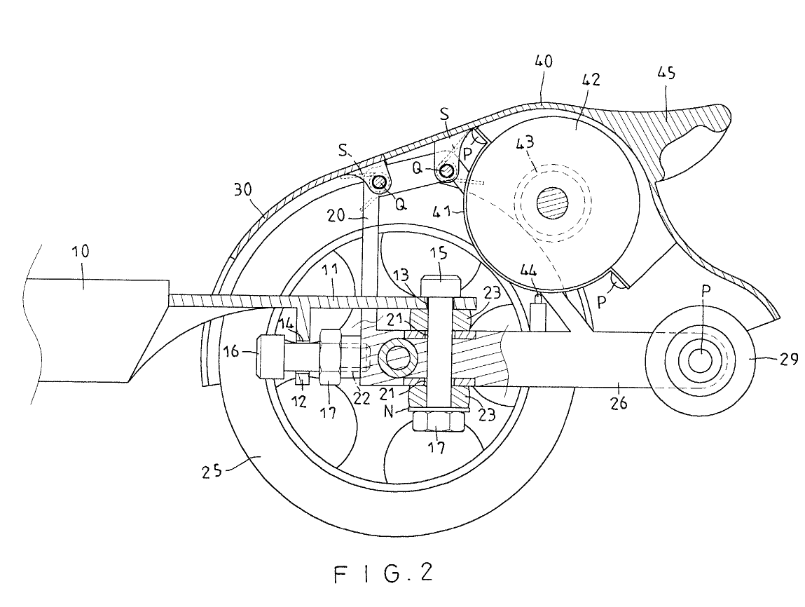

Referring to the drawings and initially to FIGS. 1 and 2, a drive device of a motorized scooter in accordance with the present invention comprises a horizontal connecting plate 11 mounted on the rear end of the frame 10 of the scooter and defining a horizontal connecting hole 13, and a vertical connecting plate 12 mounted on the bottom of the horizontal connecting plate 11 and defining a vertical connecting hole 14. A bolt 15 and a nut 17 are used to pivot the horizontal connecting hole 13 to the axial hole 21 of the wheel seat 20, and a bolt 16 and a nut 17 are used to pivot the vertical connecting hole 14 to the radial threaded hole 22 of the wheel seat 20. The diameter of the horizontal connecting hole 13 and the vertical connecting hole 14 is greater than that of the bolts 15 and 16, so that the wheel seat 20 may deflect horizontally and vertically. The top and bottom of the axial hole 21 of the wheel seat 20 are fitted with an elastomer 23 for providing a vibration-proof function. The wheel axles 24 of the two sides of the wheel seat 20 are pivoted with two wheels 25 by a screw P and a washer N. The mediate position of the rear of the wheel seat 20 is provided with two spaced positioning plates 26. A shaft 28 is extended through the positioning holes 27 of the positioning plates 26, and is engaged with a screw P, so as to pivot an auxiliary wheel 29. The front side and rear side of the top of the wheel seat 20 are respectively pivoted with a wheel cover 30 and 40 by a pin Q and a torsion spring S. The wheel cover 30 may contact the wheels 25 to provide a brake effect. The inside of the wheel cover 40 is secured with a motor 42 by two semi-circular brackets 41 and screws P, and the two ends of the motor 42 are fitted with a drive wheel 43 to contact and drive the wheels 25. The wheel seat 20 is provided with a contact switch 44, so that when the wheel cover 40 is stepped, the motor 42 is started due to contacting the contact switch 44. The wheel cover 40 is provided with a handle 45 to facilitate transportation.

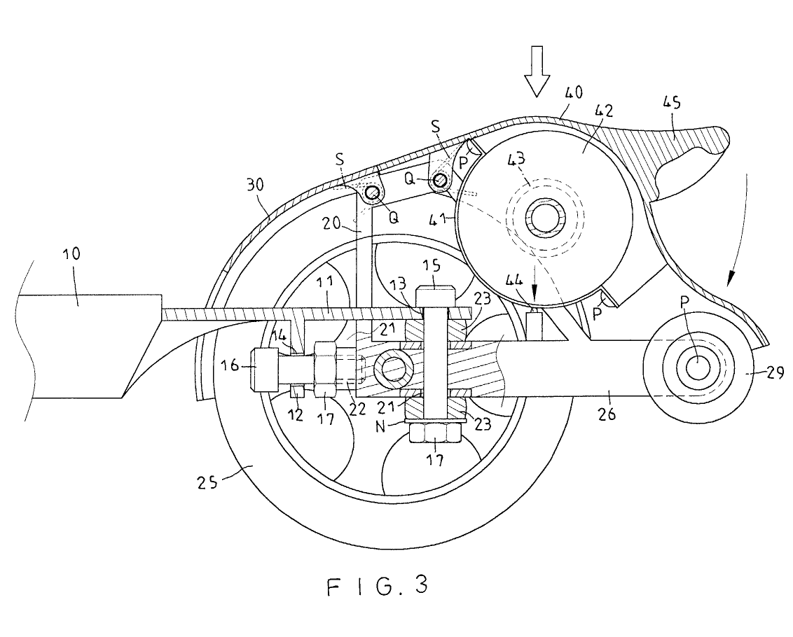

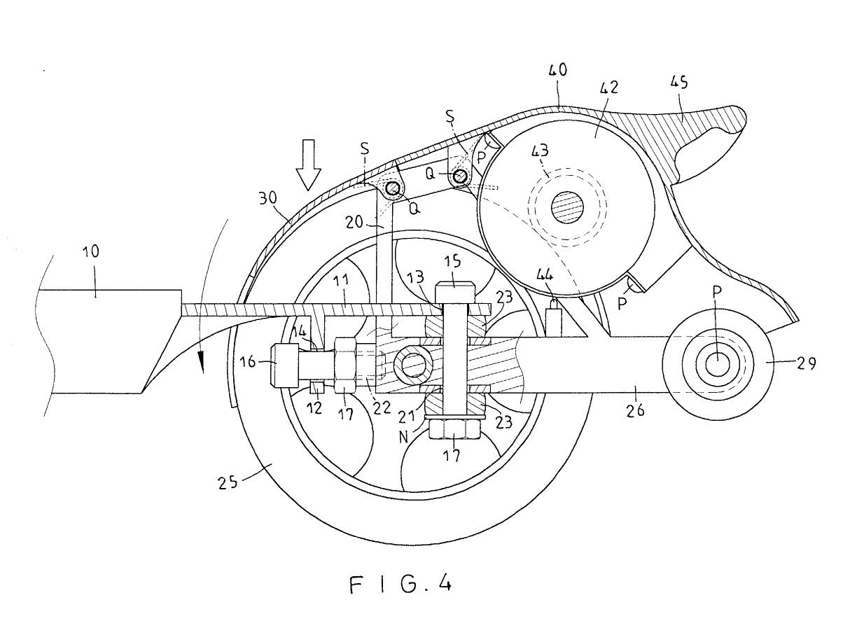

Referring to FIGS. 3 and 4, the user's one foot may tread the wheel cover 30 for braking the scooter, and tread the wheel cover 40 for driving the scooter. The motor 42 is controlled by the contact switch 44 on the wheel seat 20. The motor 42 is started by the contact switch 44 when the user's one foot treads the wheel cover 40. When the motor 42 is driven, the scooter will not be braked, and when the scooter is braked, the motor 42 will not be driven.

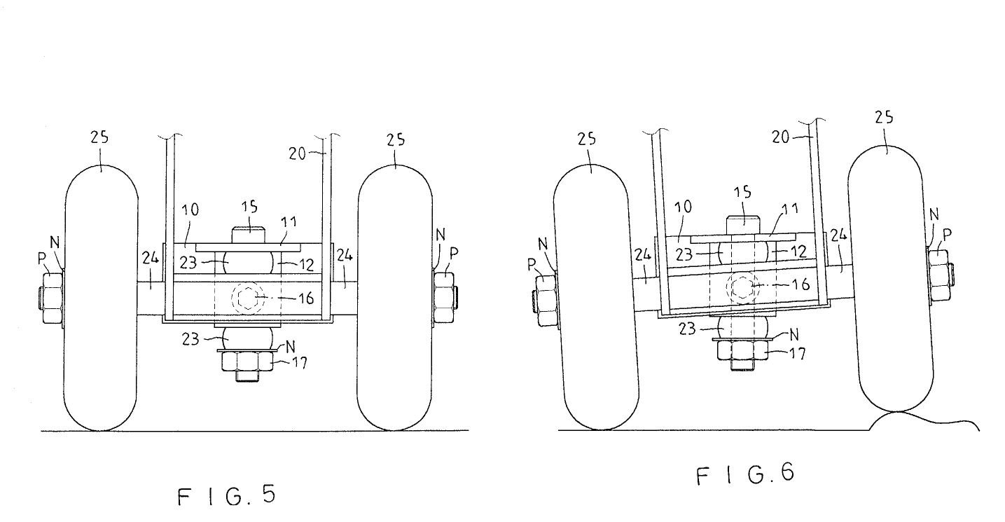

Referring to FIGS. 5 and 6, the horizontal connecting hole 13 of the horizontal connecting plate 11 of the frame 10 has a diameter greater than that of the bolt 15 of the wheel seat 20, so that the wheel seat 20 may adjustably sway vertically. When the wheels 25 are ridden on a rugged road, the frame 10 maintains its balance without being affected by vertical sway of the wheels 25. In addition, the elastomer 23 provides a shock absorbing function, thereby reducing the vibration, and increasing the stability and safety of manipulation.

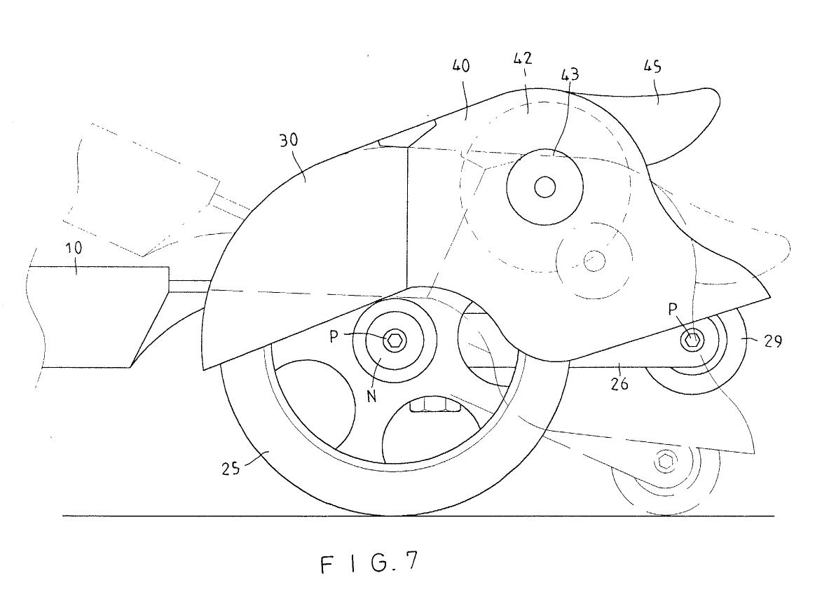

Referring to FIG. 7, when the motor 42 is started, the accident pulse of the motor 42 causes the rider to lean rearward, so that the front wheel of the scooter is lifted. Thus, when the frame 10 is lifted, the auxiliary wheel 29 and the wheels 25 may rigidly form a three-point support effect, thereby efficiently maintaining the balance of the frame 10.

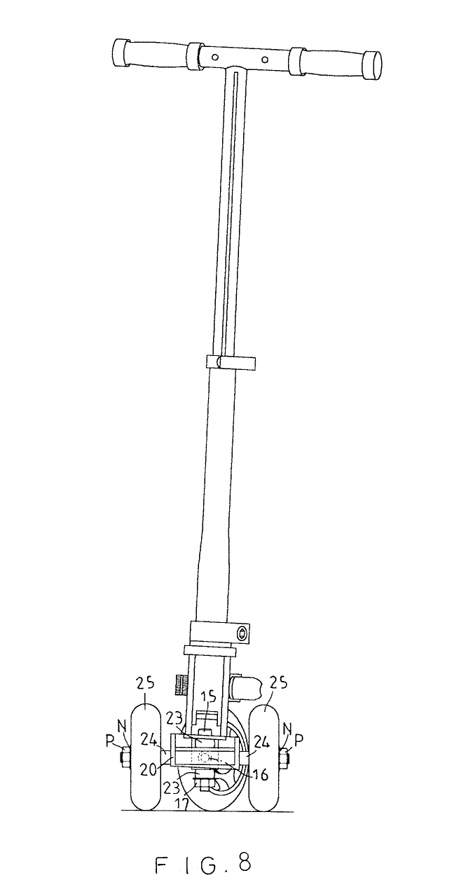

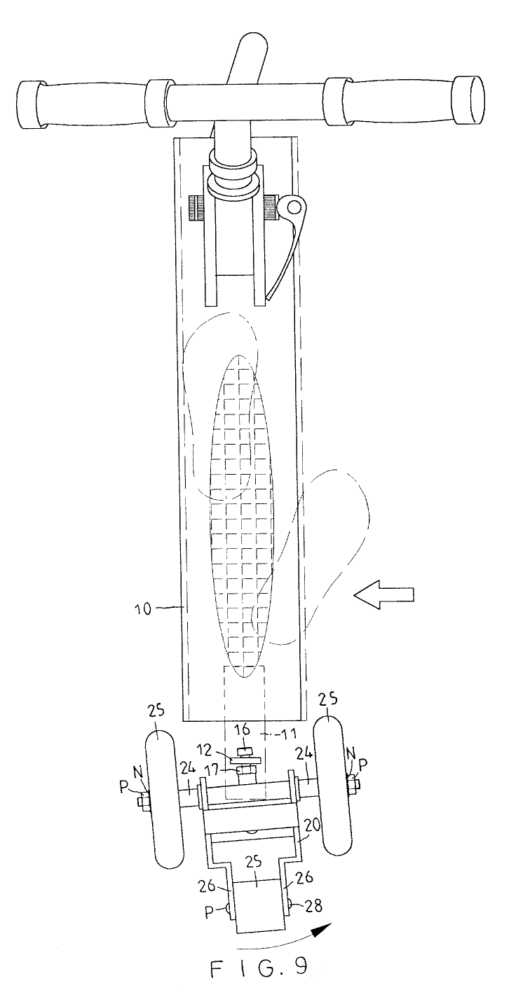

Referring to FIGS. 8 and 9, the vertical connecting hole 14 of the vertical connecting plate 12 of the frame 10 has a diameter greater than that of the bolt 16 of the wheel seat 20, so that the wheel seat 20 may adjustably sway horizontally. When the scooter is turned, the frame 10 is inclined toward the turning direction, and the wheel seat 20 is turned with the frame 10, thereby decreasing the centrifugal force, and preventing the wheel 25 at the outer side from leaving the ground, so as to increase the balance of the frame 10.

Although the invention has been explained in relation to its preferred embodiment as mentioned above, it is to be understood that many other possible modifications and variations can be made without departing from the scope of the present invention.

What is claimed is:

1. A drive device of a motorized scooter, comprising:
a horizontal connecting plate mounted on a rear end of a frame of a scooter and defining a horizontal connecting hole, a vertical connecting plate mounted on the horizontal connecting plate and defining a vertical connecting hole, the horizontal connecting hole pivoted to an axial hole of a wheel seat, the vertical connecting hole pivoted to a radial threaded hole of the wheel seat, the horizontal connecting hole and the vertical connecting hole having a slightly greater diameter, so that the wheel seat may deflect horizontally and vertically, the wheel seat having two sides provided with two wheels and a rear side provided with an auxiliary wheel having a smaller diameter, the wheel seat having a top having a front side and a rear side respectively pivoted with two wheel covers by a pin and a torsion spring, the front wheel cover in contact with the two wheels to provide a brake effect, the inside of the rear wheel cover secured with a motor, and the two ends of the motor fitted with a drive wheel to contact and drive the two wheels.

2. The drive device of a motorized scooter in accordance with claim 1, further comprising an elastomer mounted between the frame and the wheel seat.

3. The drive device of a motorized scooter in accordance with claim 1, wherein the drive wheel and the two wheels are provided with a friction plane or arcuate face therebetween for driving by contact.

4. The drive device of a motorized scooter in accordance with claim 1, wherein the wheel cover for driving has an outer periphery provided with a handle.

5. The drive device of a motorized scooter in accordance with claim 1, further comprising a contact switch mounted between the wheel cover for driving and the wheel seat for starting the motor.
